(19) United States
(12) Patent Application Publication
(10) Pub. No.: US 2005/0184579 A1
(43) Pub. Date: Aug. 25, 2005

(54) Vehicle wheel with disc forming outer tire retaining flange

(75) Inventors: Darrell Bryant, Sharpsburg, KY (US); Keith Wittwer, Paris, KY (US); Yoshihiiro Haso, Lexington, KY (US); Ricky Roe, Paris, KY (US)

Correspondence Address: CONNOLLY BOVE LODGE & HUTZ, LLP, P O BOX 2207, WILMINGTON, DE, 19899, US

(73) Assignee: Central Motor Wheel of America, Inc.

(21) Appl. No.: 10/786,498

(22) Filed: Feb. 25, 2004

(51) Int. Cl. B60B 3/10

(52) U.S. Cl. 301/63.105

(57) ABSTRACT

An automotive passenger vehicle, full-face styled wheel construction having a sheet metal disc with an outer peripheral portion formed to provide an outboard tire bead retaining flange. The rim includes an inboard tire bead retaining flange, an inboard tire bead seat portion, a drop-center well portion and an outboard bead seat portion. The outboard edge of the rim has a radially in-turned flange portion extending circumferentially continuously around the rim edge with a plurality of serrations on an outside surface thereof that engage the disc. The rim and disc parts are permanently joined by a circumferentially continuous weld between the radially in-turned flange portion of the rim and the disc and into at least some of the serrations. The serrations eliminate or substantially reduce weld splatter by allowing weld gases to flow and escape evenly, and reduce weld material runout by providing high points for leveling during welding. Machining of the weld is eliminated.

### BACKGROUND OF THE INVENTION

The present invention relates to vehicle wheels, and more particularly to automotive passenger vehicle wheels fabricated from sheet metal.

For well over fifty years automotive passenger vehicle wheels adapted for mounting of pneumatic tires thereon have been fabricated from sheet metal, usually steel, to provide a rolled one-piece rim with a drop-center well to which is affixed a disc or body adapted for mounting the wheel to the hub or other wheel mounting part of a vehicle. Usually the rim is made with both inboard and outboard bead seats and associated tire bead retaining flanges, and the disc is secured to the base of the drop-center well of the rim. However, so called “full-face” wheels have also been provided wherein the disc extends generally radially outwardly around its outer periphery to also form the outboard tire bead retaining flange, and the rim is formed at its outboard edge to provide the outboard bead seat and a free edge which is welded or otherwise affixed to the inboard face of the full-face disc part. Such “full-face” wheels enable the wheel designer to provide a more unique and distinct styling appearance to the outboard face of the wheel, thereby obviating the need for attaching ornamental wheel covers and their attendant problems and cost. Examples of such full-face wheels of the prior art may be found in U.S. Pat. Nos. 2,083,326; 2,016,525; 2,057,565; and 4,610,482.

Also, known are so-called “styled” wheels wherein the disc is stamped or drawn in progressive deep-draw die operations to impart a decorative, highly contoured configuration to the disc. Although for the most part such styled wheels comprise a conventional disc and rim assembly wherein the disc is affixed to the drop-center base of a full-rim section, styled steel wheels have also been produced in “full-face” type wheels. In at least one commercial construction both the disc and rim parts are each made as separate stampings and then joined together by a circumferentially continuous weld at the outboard edge of the outboard rim part. Such construction requires very tight quality control of the circumferentially continuous weld since the same has to be air-tight for use with tubeless tires. The outboard full-face disc-rim part is provided with deep ribs with small-radiused corners, and requires a very high quality, deep-drawing steel.

Other prior art of interest to, but not suggestive of, the present invention is set forth in the following United States and foreign patents:

| | | |
|---|---|---|
| U.S. Pat. No. 1,589,449 | June 1926 | Williams |
| U.S. Pat. No. 2,608,236 | August 1952 | Hunt |
| U.S. Pat. No. 3,506,311 | April 1970 | Nobach |
| France 1,003,182 | March 1952 | Michelin |

With the increasing popularity in automobile passenger cars of both U.S. and foreign manufacture of front wheel drive systems, wheel designs have had to be modified to provide a much greater disc “offset”, i.e. the axial spacing of the disc outboard of the mid-plane of the wheel as defined by the inboard and outboard tire bead seats, to accommodate the larger disc brakes and other associated wheel hub and drive structure of front wheel drive systems. The aforementioned commercial full-face styled wheel construction is not suited for such front wheel drive requirements. Accordingly, much effort has gone into attempting to successfully design and manufacture a full-face styled, steel fabricated wheel which will provide both the required large disc offset and other parameters such as a highly stylized, full-face appearance, and a strong and reliable air-tight circumferential weld joint, while also being capable of meeting the severe fatigue life specifications required on current automotive passenger vehicle wheels and yet remaining cost competitive with high offset front wheels of dual flanged rim and interior press fit disc construction.

### SUMMARY OF THE INVENTION

Accordingly, it is an object of the present invention to provide an improved vehicle wheel construction which overcomes the aforementioned problems and satisfies present-day fatigue life and manufacturing cost standards and provides a full-face styled wheel which may be designed as desired to impart an aesthetically pleasing ornamental appearance on the outboard side of the wheel.

In accordance with the present invention, an automotive passenger vehicle wheel comprises a rim and a disc. The rim has an outboard edge including a radially in-turned rim flange portion extending circumferentially continuously around the rim edge. The rim flange portion has serrations on an outboard side thereof, and these serrations engage an outer peripheral portion of the disc. A continuous weld between the serrations of the radially in-turned rim flange portion and the outer peripheral portion of the disc secure the rim and disc together.

### BRIEF DESCRIPTION OF THE DRAWINGS

Other objects, as well as features and advantages of the present invention will become apparent to persons of ordinary skill in the art from a reading of the following detailed description taken in conjunction with the accompanying drawings wherein similar parts are identified by similar reference characters and in which:

FIG. 1 is a fragmentary elevational view of the outboard side of an exemplary, but preferred, embodiment of a vehicle wheel constructed in accordance with the present invention, a portion of the wheel being broken away to better illustrate detail;

FIG. 2 is a central, radial cross sectional view taken on the line 2-2 of FIG. 1; and

FIG. 3 is an enlargement of the portion of FIG. 2 indicated by the circle designated 3 in FIG. 2.

### DETAILED DESCRIPTION OF THE INVENTION

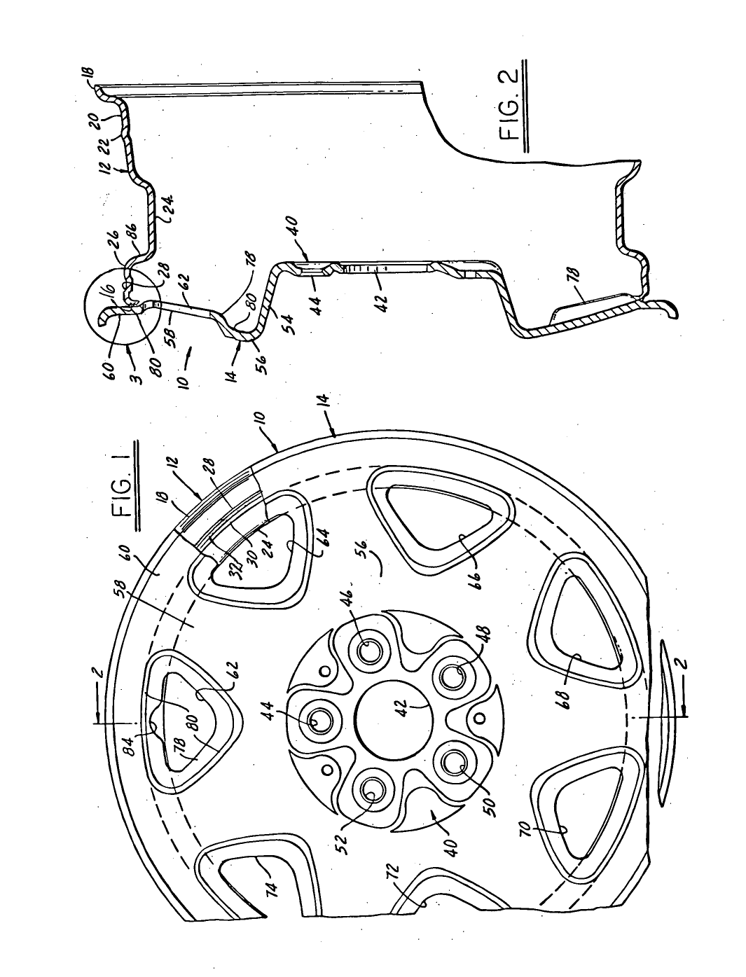

Referring in more particularity to the accompanying drawings, one embodiment of a wheel 10 made in accordance with the construction of the present invention is shown in FIGS. 1-3. Wheel 10 comprises a two-piece assembly made up of rim 12 and a disc 14 permanently and securely joined together by a circumferentially continuous, air impermeable weld joint 16. Rim 12 is preferably made from strip steel stock by coiling, butt welding and roll forming in a conventional manner so as to provide, as best seen in FIG. 2, an inboard tire bead retaining flange 18, an inboard tire bead seat 20, a safety hump 22, a drop-center well portion 24, an outboard bead seat safety hump 26 and an outboard tire bead seat 28.

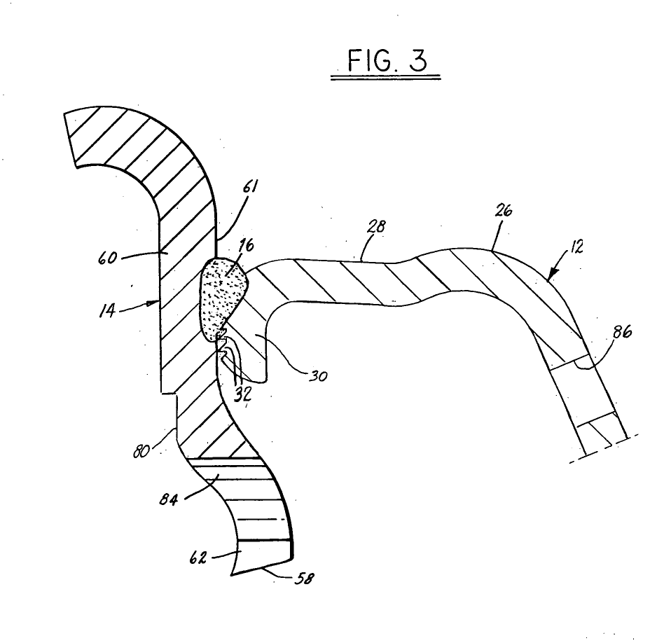

In accordance with one feature of the present invention, and as best seen in FIG. 3, the outboard free edge of rim 12 prior to wheel assembly is formed so as to have a radially in-turned flange portion 30 with a number of circumferentially continuous serrations 32 on the outboard surface of the flange portion. As explained more fully below, the serration 32 play a key role in the weld 16 between the in-turned flange portion of rim 12 and the disc 14.

The disc part 14 of wheel 10 comprises a central bolt circle wheel mounting portion 40 having a pilot center opening 42 concentric with the axis of wheel 10. Wheel mounting bolt holes 44, 46, 48, 50, 52 are provided in a circular array in mounting portion 40 in the usual fashion. Disc 14 has an intermediate portion in the form of a frusto-conical hat section 54 integral with and extending radially outwardly and axially outboard from mounting portion 40 defining a crown portion 56, which in turn merges integrally with a vent opening portion 58 inclined slightly inboard of the wheel. Disc portion 58 extends radially outwardly and merges integrally with an outer peripheral portion in the form of an outboard tire bead retaining flange portion 60 which defines the outer periphery of the disc. It will thus be seen that disc 14 serves as a so-called “full-face” disc and rim part in that the disc 14 does not terminate at a junction with the well base 24 of rim 12, but rather continues beyond the rim base to provide the outboard tire bead retaining flange 60 of the rim and wheel assembly.

Disc 14 is provided with an annular array of several vent holes 62, 64, 66, 68, 70, 72, 74 formed in the vent opening portion 58 of the disc. These vents holes are each individually blanked in an associated axially inboard depressed portion 78 which defines the margin of the associated vent hole 62-74. The outer periphery of portion 78 may be defined by an axially inwardly or inboard offset embossment portion 80. Marginal portion 80 is preferably formed in a die strike and coining operation to reduce stress cracks around the margin of the vent holes to thereby improve disc fatigue life, as is well understood in the art. One of the vent holes, i.e. hole 62, also has a valve stem clearance notch 84 which is aligned with a valve stem hole 86 in rim 12.

Once rim 12 has been assembled next to disc 14 such that the parts assume their relative positions shown in FIGS. 2 and 3, assembly of wheel 10 is completed by permanently affixing rim 12 to disc 14 by forming a circumferentially continuous arc weld 16 between the serrations 32 on the outside surface of flange portion 30 and the disc 14, as best seen in FIG. 3. Weld 16 is preferably full penetration arc weld so as to securely join the rim and disc together and form an air-tight seal at the junction of these parts.

As a further feature of the invention, the in-turned flange portion 30 of rim 12 provides sufficient back-up metal for weld 16 so as to prevent weld burn-through radially inwardly of the joint despite the full penetration nature of the weld. Also, the serrations 32 function to provide an improved attachment weld by allowing welding gases to flow and escape evenly and weld splatter is eliminated or substantially reduced. Moreover, lateral runout of weld metal is reduced by the creation of high points at the serrations for leveling during welding. Most significant is the fact that machining is not necessary either before or after assembly. Also, rollover consistency of the in-turned flange portion 30 with the serration thereon eliminates wobble between the rim and disc for improved mating of components.

From the foregoing description it will now be apparent that the present invention provides a full-face styled wheel of fabricated sheet steel construction which amply fulfills the aforestated objects and offers many advantages, including those set forth above. Wheel 10, when constructed as described above, has greatly improved fatigue life without increasing the cost of manufacture or difficulty of assembly. These improved results are believed to derive from several cooperative features of the foregoing wheel construction design. The radially in-turned flange portion 30 of the rim and the serrations 32 on the outside surface thereof increase the hoop strength at the free edge of the rim as well as contribute to improved reliability, air impermeability and strength of the full penetration weld joint 16. Rim flange portion 30, by preventing weld burn-through, also lessens manufacturing costs by reducing defective assemblies and thus scrap loss. Finishing operations are eliminated. Moreover, these advantages are obtained in a full-face wheel construction so that aesthetic styling contours are now obtainable in a wheel which also can meet O.E.M. passenger car service and fatigue life testing requirements, and, at the same time, provide a large disc “offset” dimensional relationship to accommodate front wheel drive systems. It will, of course, be understood that other configurations may be imparted to disc 14 to vary the ornamental appearance thereof in accordance with a variety of styled steel wheel designs by retaining the characteristic features and advantages of the invention as described above.

1. An automotive passenger vehicle wheel construction having a disc fabricated from sheet metal and including a central bolt circle mounting portion, an intermediate portion extending generally radially outwardly from the bolt circle mounting portion and an outer peripheral portion surrounding the intermediate portion, the disc outer peripheral portion being formed to provide an outboard tire bead retaining flange for the wheel, and a rim part including an inboard tire bead retaining flange, an inboard tire bead seat portion, a drop-center well portion and an outboard bead seat portion, the outboard edge of the rim part comprising a radially in-turned rim flange portion extending circumferentially continuously around the rim edge adjacent the rim outboard bead set, the rim flange portion having serrations on an outboard side thereof, the serrations engaging the outer peripheral portion of the disc, and a continuous weld between the radially in-turned rim flange portion and the outer peripheral portion of the disc and into at least some of the serrations securing the rim and disc together.

2. The wheel as set forth in claim 1 wherein the disc has an annular array of vent holes disposed in the intermediate section and axially inboard offset marginal portions individually surrounding each of the vent holes.

3. The wheel as set forth in claim 2 wherein the vent hole offset marginal portions are produced by a coining operation to reinforce the disc against stress fatigue in the vicinity of each vent hole.

4. The wheel as set forth in claim 2 wherein the rim is roll formed from sheet steel and the disc is fabricated in stamping operations from sheet steel.
